(19) United States
(12) Patent Application Publication
(10) Pub. No.: US 2015/0292665 A1
(43) Pub. Date: Oct. 15, 2015

(54) GASKET FOR SEALING OF THREADED COUPLINGS

(71) Applicant: Jarle STRAND, Haslum (NO)

(72) Inventor: Jarle Strand, Haslum (NO)

(21) Appl. No.: 14/437,613

(22) PCT Filed: Oct. 17, 2013
(86) PCT No.: PCT/NO2013/000048

§ 371 Date: Apr. 22, 2015

(30) Foreign Application Priority Data
Oct. 22, 2012 (NO) 20121237

(51) Int. Cl. F16L 47/22; B29C 65/68; F16L 15/04

(52) U.S. Cl. CPC F16L 47/22; F16L 15/04; B29C 65/68; B29K 2027/18

(57) ABSTRACT

Gasket for sealing of couplings with threads carried out in heat-shrinkable polymer which is shrinked by heat such that it encloses the outer threads on one of the two components that are to be connected.

### BACKGROUND

The invention relates to a gasket for sealing of couplings with threads.

Couplings with threads are often used for connecting tubular parts and associated components. Examples of such components are valves/taps, union joints and reduction sleeves/muffs.

The couplings shall normally be tight. Therefore a gasket is necessary. Such couplings are very commonplace in many installations. It is therefore adequate that the couplings can be mounted and sealed with a gasket. The present invention is a gasket which can be mounted quickly onto the thread parts both by a plumber and by a manufacturer of the parts.

There is a plurality of known solutions in order to seal couplings with threads. Most of these solutions have been known for a long time. A used solution for sealing of couplings with threads is usage of hemp which is wound around the thread part with outer threads.

The hemp has often also been lubricated with various kinds of substances which provide a combination of sealant and lubrication. Subsequently, the two components are connected to each other in that the component that has been applied hemp is screwed into the inner threads of the other component. It is the hemp itself which is the main sealing means in this solution. Since hemp expands in water, water in the tubular parts will provide moisture to the hemp which then will swell and seal the coupling. This solution provides a good sealing of the coupling. It has also the property that the coupling may be adjusted by rotating the two connected components without the sealing being damaged. A drawback with this solution is high time usage.

It is time consuming to process the hemp and to wind it around the thread part. It takes time too to apply sealing/lubrication substance. The solution requires also that it must be applied so much hemp that it often results into relatively high friction/counterforce when the threaded components shall be connected. There does not seem to exist manufacturers which supply components with hemp as a gasket material readily applied.

A second known solution is usage of so-called thread tape. This is often a polymer as a tape, typically with reinforcing fibers in longitudinal direction of the tape. The tape is wound around the outer threads the same way as in the solution above, and the components are connected corresponding to the above description for hemp. This is a time-consuming solution too. One can neither adjust the coupling later since this will damage the sealing effect of the tape.

There does not seem to exist manufacturers which supply components with this type of readily applied sealing.

A third solution is the usage of a liquid gasket in a solvent. In this solution, the components are screwed to each other first. Subsequently, the liquid sealing is dripped onto the transition between the two components and it penetrates then into the threads. When the solvent has evaporated, the sealing substance constitutes a gasket. A drawback with this solution is that it cannot be adjusted later since any rotation would damage the gasket. It is also a drawback with this solution, that there is no sealing substance on the components prior to dripping. The components will therefore rotate quite readily in relation to each other prior to adding the sealing substance. Such a loose coupling is difficult to adjust, notably if there are many components that are to be connected prior to adding the sealing substance.

### SUMMARY

The present invention consists of a gasket element carried out in a heat-shrinkable polymer. A heat-shrinkable polymer has the property that it shrinks when it is exposed for a temperature above a certain threshold. Accurate temperature will depend on which polymer being used. Typically, a ring-shaped structure of heat-shrinkable polymer will be reduced in size during shrinking,—the geometrical structure will substantially be maintained, but the structure will have a reduced diameter. In the present invention, the gasket element is carried out in heat-shrinkable polymer which is shrinked by heat such that it encloses the outer threads on one of the two components that are to be connected. This may for example be achieved by using a gasket element which is cylindrical. This element is placed over the outer threads of a component and is shrinked subsequently by heat.

When this component with the shrinked gasket element is screwed into a second component, the gasket element will seal the coupling.

### DETAILED DESCRIPTION OF PREFERRED EMBODIMENTS

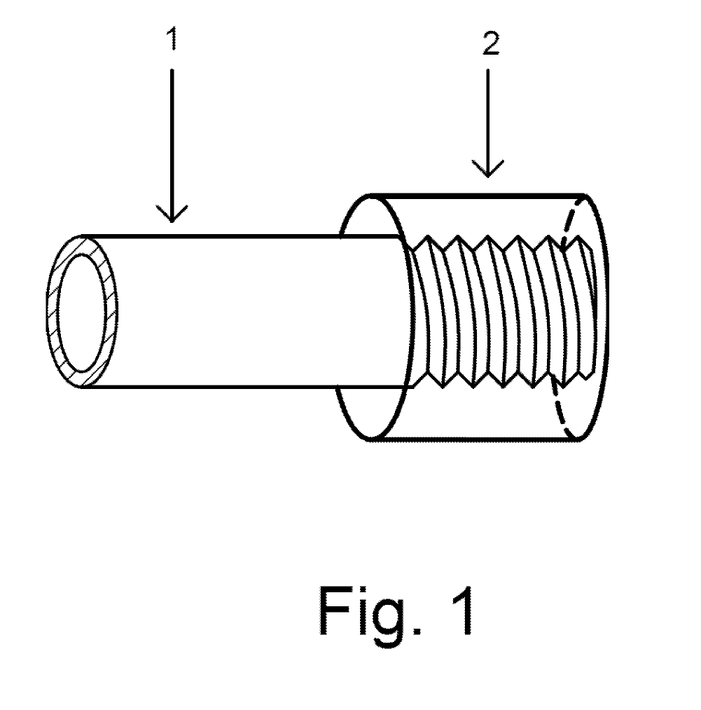

FIG. 1 shows a portion of a component with outer threads (1) and a gasket element made of a heat-shrinkable polymer (2). The gasket element is placed over the outer threads. When the gasket element is heated, it shrinks and encloses the threads. According to a preferred embodiment, the gasket element (1) is of cylindrical shape as shown in FIG. 1.

According to preferred embodiments, the gasket element is made of polytetrafluorineethylene, polyalken or polyvinylchloride. These three embodiments have all been tested with a good result. Application of water, oil or other liquid onto the gasket element after shrinking, but prior to mounting, has the effect that the coupling becomes easier to assemble.

According to a preferred embodiment, the cross-section of the wall of the gasket element is tapered in the direction transversely to the threads. In this way, it is achieved that the gasket seals better, the longer the components are screwed onto the threads.

1. Application of heat-shrinkable polymer for sealing of couplings with threads, wherein the heat-shrinkable polymer is shrinked by heat such that it encloses the outer threads on one of the two components that are to be connected.

2. Application according to claim 1, wherein the heat-shrinkable polymer is of cylindrical shape.

3. Application according to claim 2, wherein the cross-section of the wall in the cylindrically shaped polymer is tapered.

4. Application according to claim 1, wherein the heat-shrinkable polymer is made from polytetrafluorineethylene.

5. Application according to claim 1, wherein the heat-shrinkable polymer is made from a polyalken/polyolefin.

6. Application according to claim 1, wherein the heat-shrinkable polymer is made from polyvinylcloride.

7. Gasket for sealing of thread-based couplings, the gasket including a heat-shrinkable polymer being shrunk by heat application onto the outer threads of one of the components that are to be connected.

8. Gasket according to claim 7, wherein the gasket is of cylindrical shape.

9. Gasket according to claim 8, wherein the cross-section of the wall in the cylindrically shaped gasket is tapered in the direction transversely to the threads.

10. Gasket according to claim 7, wherein the gasket is made from polytetrafluorineethylene.

11. Gasket according to claim 7, wherein the gasket is made from a polyalken/polyolefin.

12. Gasket according to claim 7, wherein the gasket is made from polyvinylcloride.

13. Method for applying a gasket for thread-based coupling, comprising the following steps:
placing a heat-shrinkable gasket onto the outer threads of one of the components that are to be connected,
applying heat to shrink the gasket onto the threads.
